(19) United States
(12) Patent Application Publication
(10) Pub. No.: US 2018/0179369 A1
(43) Pub. Date: Jun. 28, 2018

(54) THERMOPLASTIC RESIN COMPOSITION AND METHOD FOR PRODUCING THERMOPLASTIC RESIN COMPOSITION

(71) Applicant: IDEMITSU KOSAN CO., LTD., Tokyo (JP)

(72) Inventors: Shinji Ito, Ichihara-shi, Chiba (JP); Shinobu Yamao, Ichihara-shi, Chiba (JP); Yoshihito Koyama, Ichihara-shi, Chiba (JP)

(73) Assignee: IDEMITSU KOSAN CO., LTD., Tokyo (JP)

(21) Appl. No.: 15/579,340

(22) PCT Filed: Jun. 10, 2016
(86) PCT No.: PCT/JP2016/067450

§ 371 Date: Dec. 4, 2017

(30) Foreign Application Priority Data
Jun. 11, 2015 (JP) 2015-118530

(51) Int. Cl. C08L 23/12; C08H 8/00; D21C 3/00; D21C 3/20; D21C 3/22

(52) U.S. Cl. CPC C08L 23/12; C08H 8/00; C08L 2205/035; D21C 3/20; D21C 3/22; D21C 3/006

(57) ABSTRACT

A thermoplastic resin composition of the invention contains a cellulose-containing solid material obtained after heat treatment of a botanical biomass as a raw material in a mixed solvent of water and at least one alcohol selected from aliphatic alcohols having 4 to 8 carbon atoms, and a thermoplastic resin. Accordingly, a thermoplastic resin composition can be provided, which, as compared with a case of incorporating conventional cellulose nanofibers or lignocellulose nanofibers in a resin composition, simplifies the production step, improves miscibility with a thermoplastic resin and improves thermal stability.

### TECHNICAL FIELD

The present invention relates to a thermoplastic resin composition containing a cellulose-containing solid material obtained from a botanical biomass as a raw material, and a thermoplastic resin, and to a method for producing a thermoplastic resin composition.

### BACKGROUND ART

With the increase in environmental issues and from the viewpoint of construction of circulating society, utilization of regenerated resources is desired. Among them, botanical biomass-derived cellulose nanofibers have attracted great attention as combined with the recent progress of production techniques.

Cellulose nanofibers indicate a nanosize ultrafine fibrous substance having a mean width of a few to 20 nm or so and a mean length of 0.5 to a few μm or so, which are obtained through chemical and/or mechanical opening treatment of botanical fibers, and are characterized by the following:

They have a tensile strength of 5 times or more that of steel.

They have little deformation by heat (about 1/50 that of glass).

They are sustainable plant-derived resources with few environmental burdens.

Using cellulose nanofibers having such characteristics as alternatives for resin reinforcing materials such as talc, glass fibers or the like, lighter and higher-efficiency resin compositions can be produced and are expected to be useful in various fields of buildings, automobiles, etc.

On the other hand, cellulose nanofibers have heretofore been produced by opening crude pulp generated in production processes in pulp industry (but not containing lignin) into nanosize, using a grinder or a high-pressure homogenizer.

However, the method requires much energy for production, and the production cost is therefore high.

In addition, the cellulose nanofibers obtained according to the above-mentioned method have a large surface area and have a hydroxyl group in the surface thereof. The water content is 90 to 99% or so, and is high. However, dehydration treatment is difficult, and therefore the defect of the cellulose nanofibers is that it is extremely difficult to mix them with a hydrophobic resin.

Recently, for compensating the above-mentioned defect of cellulose nanofibers, a technique of refining cellulose in a kneader using a vinyl resin to give microfine particles has been proposed (see PTL 1). The cellulose used in PTL 1 is a purified cellulose powder and has a low water content. In addition, the resin used therein has a high polarity and a high affinity with cellulose, including poly(meth)acrylates, etc.

In place of the above-mentioned crude pulp, use of lignocellulose nanofibers using a botanical biomass such as a lignin-containing wood powder or the like as a raw material has been proposed (see PTL 2). Lignin contained in lignocellulose nanofibers is relatively hydrophobic, and therefore, as compared with conventional cellulose nanofibers, the water content thereof is low and dehydration treatment is unnecessary, and consequently, reduction in production cost is expected.

### CITATION LIST

### Patent Literature

PTL 1: JP 2013-116928 A

PTL 2: JP 5398180 B2

### SUMMARY OF INVENTION

### Technical Problem

In the example of refining cellulose after purification described in PTL 1, the cellulose pretreatment step is troublesome, and there is still room for improvement in point of energy balance in production and production cost increase.

The lignocellulose nanofibers described in PTL 2 contain hemicellulose and cellulose in addition to lignin. Hemicellulose is thermally unstable, and therefore the lignocellulose nanofibers are poor in thermal stability as compared with conventional cellulose nanofibers. Consequently, there is still room for improvement in point of thermal stability.

Given the situation, an object of the present invention is to provide a thermoplastic resin composition and a method for producing a thermoplastic resin composition, in which, as compared with the case where conventional cellulose nanofibers, lignocellulose nanofibers are incorporated in a resin composition, the production step can be simplified, the performance in mixing with a thermoplastic resin can be improved and the thermal stability can be improved.

### Solution to Problem

The present inventors have found that the above-mentioned problems can be solved by using a botanical biomass as a raw material and using a cellulose-containing solid material obtained by treatment under specific conditions.

Specifically, the gist of the present invention includes the following:

[1] A thermoplastic resin composition containing a cellulose-containing solid material obtained after heat treatment of a botanical biomass as a raw material in a mixed solvent of water and at least one alcohol selected from aliphatic alcohols having 4 to 8 carbon atoms, and a thermoplastic resin.
[2] The thermoplastic resin composition according to [1], wherein the thermoplastic resin is contained in an amount of 30% by mass or more and 99.9% by mass or less as a solid content and the cellulose-containing solid material is contained in an amount of 0.1% by mass or more and 70% by mass or less, based on the total amount of the thermoplastic resin composition.
[3] The thermoplastic resin composition according to [1] or [2], wherein the cellulose-containing solid material is obtained after treatment under the following conditions:

Condition A: the concentration of the raw material to be charged into the mixed solvent is 1% by mass or more and 50% by mass or less,

Condition B: the treatment temperature is 100° C. or higher and 350° C. or lower, and

Condition C: the treatment time is 0.1 hours or more and 10 hours or less.

[4] A thermoplastic resin composition containing a cellulose-containing solid material obtained after heat treatment of a botanical biomass as a raw material in a mixed solvent of water and at least one alcohol selected from aliphatic alcohols having 4 to 8 carbon atoms, and a thermoplastic resin, wherein the cellulose-containing solid material contains, as a solid content, cellulose and a cellulose degradation product obtained through degradation of cellulose in an amount of 60% by mass or more and 90% by mass or less, lignin in an amount of 5% by mass or more and 35% by mass or less, and hemicellulose and a hemicellulose degradation product obtained through degradation of hemicellulose in an amount of 0% by mass or more and 5% by mass or less, based on the total amount of the cellulose-containing solid material.
[5] The thermoplastic resin composition according to any of [1] to [4], wherein the thermoplastic resin is an amorphous thermoplastic resin having a glass transition temperature of 200° C. or lower, or a crystalline thermoplastic resin having a melting point of 200° C. or lower.
[6] The thermoplastic resin composition according to any of [1] to [5], wherein the thermoplastic resin is at least one selected from an olefinic resin, a styrenic resin, a nylon resin and an acrylic resin.
[7] The thermoplastic resin composition according to any of [1] to [6], wherein the thermoplastic resin is contained in an amount of 70% by mass or more and 99.9% by mass or less and the cellulose-containing solid material is contained in an amount of 0.1% by mass or more and 30% by mass or less based on the total amount of the thermoplastic resin composition.
[8] The thermoplastic resin composition according to any of [1] to [7], wherein the molar ratio of water to the alcohol (water/alcohol) in the mixed solvent is from 1/1 to 40/1.
[9] The thermoplastic resin composition according to any of [1] to [8], wherein the aliphatic alcohol is at least one selected from 1-butanol, 2-butanol and 2-methyl-1-propanol.
[10] The thermoplastic resin composition according to any of [1] to [9], wherein the botanical biomass is a herbaceous biomass.
[11] A method for producing a thermoplastic resin composition, including:

a separation step of separating a cellulose-containing solid material after heat treatment of a botanical biomass as a raw material in a mixed solvent of water and at least one alcohol selected from aliphatic alcohols having 4 to 8 carbon atoms, and

subsequently to the separation step, a mixing step of mixing a thermoplastic resin and the cellulose-containing solid material.

[12] The method for producing a thermoplastic resin composition according to [11], wherein in the mixing step, mixing is performed in such a blending ratio that the thermoplastic resin could be 30% by mass or more and 99.9% by mass or less as a solid content and the cellulose-containing solid material could be 0.1% by mass or more and 70% by mass or less, based on the total amount of the thermoplastic resin composition.
[13] The method for producing a thermoplastic resin composition according to [11] or [12], wherein in the separation step, the cellulose-containing solid material is separated after treated under the following conditions:

Condition A: the concentration of the raw material to be charged into the mixed solvent is 1% by mass or more and 50% by mass or less,

Condition B: the treatment temperature is 100° C. or higher and 350° C. or lower, and

Condition C: the treatment time is 0.1 hours or more and 10 hours or less.

### Advantageous Effects of Invention

According to the present invention, there can be provided a thermoplastic resin composition and its production method, in which, as compared with the case where conventional cellulose nanofibers, lignocellulose nanofibers are incorporated in a resin composition, the production step can be simplified, the performance in mixing with a thermoplastic resin can be improved and the thermal stability can be improved.

### BRIEF DESCRIPTION OF DRAWING

FIG. 1 is a view showing a batch-type reaction apparatus used in Examples and Comparative Examples.

### DESCRIPTION OF EMBODIMENTS

The thermoplastic resin composition of an aspect of the present invention is described in detail hereinunder.

### [Thermoplastic Resin Composition]

The thermoplastic resin composition in this aspect contains a cellulose-containing solid material obtained after heat treatment of a botanical biomass as a raw material in a mixed solvent of water and at least one alcohol selected from aliphatic alcohols having 4 to 8 carbon atoms, and a thermoplastic resin.

In the thermoplastic resin composition in this aspect, preferably, the thermoplastic resin is contained in an amount of 30% by mass or more and 99.9% by mass or less as a solid content and the cellulose-containing solid material is contained in an amount of 0.1% by mass or more and 70% by mass or less, based on the total amount of the thermoplastic resin composition.

Further, in the thermoplastic resin composition in this aspect, preferably, the cellulose-containing solid material is obtained after treatment under the following conditions:

Condition A: the concentration of the raw material to be charged into the mixed solvent is 1% by mass or more and 50% by mass or less,

Condition B: the treatment temperature is 100° C. or higher and 350° C. or lower, and

Condition C: the treatment time is 0.1 hours or more and 10 hours or less.

Here, the concentration to be charged into the mixed solvent means a ratio by mass of the raw material put into the mixed solvent to the mixed solvent, and contains any raw material component insoluble in the mixed solvent.

The thermoplastic resin composition in this aspect contains a cellulose-containing solid material obtained after heat treatment of a botanical biomass as a raw material in a mixed solvent of water and at least one alcohol selected from aliphatic alcohols having 4 to 8 carbon atoms, and a thermoplastic resin, in which the cellulose-containing solid material contains, as a solid content, cellulose and a cellulose degradation product obtained through degradation of cellulose in an amount of 60% by mass or more and 90% by mass or less, lignin in an amount of 5% by mass or more and 35% by mass or less, and hemicellulose and a hemicellulose degradation product obtained through degradation of hemicellulose in an amount of 0% by mass or more and 5% by mass or less, based on the total amount of the cellulose-containing solid material.

Hereinunder, the components contained in the thermoplastic resin composition in this aspect are described in detail.

### <Cellulose-Containing Solid Material>

Preferably, the cellulose-containing solid material is contained in an amount of 0.1% by mass or more and 70% by mass or less based on the total amount of the thermoplastic resin composition. The cellulose-containing solid material content of 0.1% by mass or more secures a sufficient reinforcing effect for the thermoplastic resin composition and its cured product. The content of 70% by mass or less secures sufficient moldability of the thermoplastic resin composition.

From the above-mentioned viewpoint, the cellulose-containing solid material content is more preferably 1% by mass or more and 60% by mass or less, even more preferably 5% by mass or more and 50% by mass or less based on the total amount of the thermoplastic resin composition.

### (Production Method for Cellulose-Containing Solid Material)

The production method for the cellulose-containing solid material is as follows. Specifically, the method for producing the cellulose-containing solid material includes extracting a cellulose-containing solid material from a raw material containing a botanical biomass.

Raw Material

As the raw material for obtaining the cellulose-containing solid material, a botanical biomass must be used. The botanical biomass includes a woody biomass and a herbaceous biomass. The woody biomass includes coniferous trees and broad-leaf trees such as cedar trees, cypress trees, false cypress trees, cherry trees, eucalyptus trees, beech trees, bamboos, etc. As the botanical biomass, ground materials may be used. In addition, the biomass may be in any form of blocks, chips or powders.

The herbaceous biomass includes trunks and empty fruit bunches of palm, fibers and seeds of palm fruits, bagasse (sugar cane and strained lees of sugar cane having a high biomass content), cane tops (tops and leaves of sugar cane), rice straws, wheat straws, corn cobs, stovers and residues (corn stovers, corn cobs, corn hulls), sorghum (including sweet sorghum) residues, Jatropha seed coats and hulls, cashew shells, switchgrass, Erianthus and energy crops, etc.

Of those, from the viewpoint of the availability and the compatibility with the production method to be employed in the present invention, a herbaceous biomass is preferred. Empty fruit bunches of palm, wheat straws, corn stovers and residues, bagasse and cane tops are more preferred, and bagasse and cane tops are even more preferred. For example, in the case of a woody material, the composition thereof includes approximately 50% by mass of cellulose, 20% by mass to 30% by mass of hemicellulose, and 20% by mass to 30% by mass of lignin.

From the raw material, a solid fraction containing cellulose as the main ingredient (referred to as cellulose-containing solid material) is extracted according to the following treatment.

Solvent for Use for Separation of Cellulose-Containing Solid Material

The solvent for use for separation of the cellulose-containing solid material is described. The alcohol for the solvent is an aliphatic alcohol having 4 to 8 carbon atoms, and undergoes two-phase separation from water at 0° C. or higher and 50° C. or lower.

Here, in the present invention, two-phase separation means a state where almost all the mixed solvent has separated in two phases, but includes a state where the aqueous phase and the alcohol phase have dissolved together though slightly. The treatment of removing alcohol from the alcohol phase includes a treatment of removing the aqueous phase slightly dissolving in the alcohol phase.

Examples of the alcohol usable as the solvent include a saturated linear alcohol such as 1-butanol, 1-pentanol, 1-hexanol, 1-heptanol, 1-octanol, etc., and additionally include an unsaturated linear alcohol. An alcohol having a branched aliphatic hydrocarbon moiety is also usable. The alcohol may also be an unsaturated branched alcohol.

Among these alcohols, from the viewpoint of two-phase separation from water at 0° C. or higher and 50° C. or lower, at least one selected from 1-butanol, 2-butanol, 2-methyl-1-propanol, 1-pentanol and 1-hexanol is preferred, and 1-butanol, 2-butanol and 2-methyl-1-propanol are more preferred.

The molar ratio of water to alcohol (water/alcohol) is preferably 1/1 to 40/1, more preferably 1.5/1 to 30/1, even more preferably 2/1 to 24/1. When the ratio of water to alcohol oversteps the above-mentioned range, water and alcohol could not undergo two-phase separation under predetermined conditions, as the case may be.

In this aspect, examples of water to be used as the solvent include tap water, industrial-use water, ion-exchanged water, distilled water, etc.

Preferred Conditions in the Step of Separating Cellulose-Containing Solid Material from Raw Material

The concentration of the raw material to be charged into the solvent of the condition A is 1% by mass or more and 50% by mass or less, preferably 3% by mass or more and 20% by mass or less, more preferably 5% by mass or more and 15% by mass or less. When the raw material concentration is less than 1% by mass, the energy amount for use for heating the solvent and for removing the solvent increases so that the energy efficiency in the production process is thereby worsened. When the material is more than 50% by mass, the solvent amount is not sufficient and the separation efficiency lowers.

The reaction temperature of the condition B is 100° C. or higher and 350° C. or lower, preferably 150° C. or higher and 300° C. or lower, more preferably 170° C. or higher and 270° C. or lower. When the temperature is lower than 100° C., lignin separation could hardly occur, but when higher than 350° C., cellulose may decompose and lignin may again polymerize to form coke unfavorably.

The reaction time of the condition C is 0.1 hours or more and 10 hours or less, preferably 0.2 hours or more and 8 hours or less, even more preferably 1 hour or more and 6 hours or less, still more preferably 1 hour or more and 3 hours or less. When the time is less than 0.1 hours, separation could hardly go on, but when more than 10 hours, cellulose may decompose and lignin may again polymerize so that the amount of coke to be formed could not be suppressed.

In the separation step, the cellulose-containing solid material that is a solid fraction in the alcohol phase and the aqueous phase is separated. According to the separation method for the cellulose-containing solid material in this aspect, the cellulose-containing solid material contained in the botanical biomass can be recovered efficiently and at a high purity as the solid fraction to be formed in the form of a deposit in the alcohol phase and the aqueous phase.

According to the separation method for the cellulose-containing solid material in this aspect, lignin contained in the raw material dissolves in the alcohol phase of the solvent. Consequently, the amount of lignin contained in cellulose, hemicellulose and their degradation products can be reduced.

Other Conditions

Apart from the above-mentioned conditions, the pressure of the reaction system in the separation step is desirably 0.5 MPa or more and 30 MPa or less. A more preferred condition may be adequately settled, as influenced by the amount of water and alcohol and by temperature. The separation step may be carried out in air. Preferably, the separation step is carried out in an atmosphere where oxygen has been reduced by nitrogen purging, for preventing polymerization by oxidation.

Though not specifically limited, the separation mode in the production method in this aspect of the present invention may be static separation. For example, an ordinary batch-type reactor, a semibatch-type reactor or the like may be used. In addition, a system where a slurry containing a botanical biomass, water and an alcohol is processed for separation with extrusion thereof via a screw, a pump or the like may be employed.

### (Characteristics of Resultant Cellulose-Containing Solid Material)

Cellulose nanofibers or lignocellulose nanofibers used as a reinforcing material for a resin composition must be opened from the viewpoint of the dispersibility thereof in the resin composition. In the opening step, in general, an opening device such as a homogenizer, a mill or the like is necessary, which, however, results in product cost increase.

As opposed to this, in the separation step for the cellulose-containing solid material in this aspect, the cellulose-containing solid material obtained in treatment in a mixed solvent of water and an alcohol is in an extremely openable state. Consequently, even though the opening step is not provided, the solid can be opened into fine fibers by kneading in the kneading step with a thermoplastic resin. Further, since the opening step can be omitted, the production cost can be significantly reduced.

In addition, by the treatment in the above-mentioned mixed solvent, the hemicellulose component may dissolve out in the solvent so that the hemicellulose component can be removed from the cellulose-containing solid material. A part of the lignin component may remain in the cellulose-containing solid material but a major part of the lignin component dissolves out in the alcohol phase.

Consequently, in the cellulose-containing solid material obtained according to the above-mentioned separation step, the ratio of the thermally-unstable hemicellulose is extremely low.

As a result, the thermal stability of the cellulose-containing solid material is higher than that derived from an ordinary botanical biomass, and therefore the thermal stability of the thermoplastic resin composition using the cellulose-containing solid material as a reinforcing material is thereby improved.

The cellulose-containing solid material extracted according to the above-mentioned method contains, as a solid content, cellulose and a cellulose degradation product obtained through degradation of cellulose in an amount of 60% by mass or more and 90% by mass or less, lignin in an amount of 5% by mass or more and 35% by mass or less, and hemicellulose and a hemicellulose degradation product obtained by degradation of hemicellulose in an amount of 0% by mass or more and 5% by mass or less, based on the total amount of the cellulose-containing solid material.

### <Thermoplastic Resin>

The thermoplastic resin contained in the thermoplastic resin composition in this aspect is described below.

Preferably, the thermoplastic resin is an amorphous thermoplastic resin having a glass transition temperature of 200° C. or lower, or a crystalline thermoplastic resin having a melting point of 200° C. or lower.

Examples of the thermoplastic resin include a polycarbonate resin, a styrenic resin, a polystyrene elastomer, a polyethylene resin, a polypropylene resin, a polyacryl resin (polymethyl methacrylate resin, etc.), a polyvinyl chloride resin, a cellulose acetate resin, a polyamide resin, a low-melting-point polyester resin typified by a polyester of a combination of terephthalic acid and ethylene glycol, or terephthalic acid and 1,4-butanediol, a polylactic acid and/or a copolymer containing a polylactic acid, an acrylonitrile-butadiene-styrene resin (ABS resin), a polyphenylene oxide resin (PPO), a silicon resin, a polybenzimidazole resin, a polyamide elastomer, etc., and a copolymer thereof with any other monomer.

The content of the thermoplastic resin in the thermoplastic resin composition of the present invention is, from the viewpoint of attaining noticeable flowability and strength, preferably 30% by mass or more and 99.9% by mass or less relative to the total amount of the resin composition, more preferably 40% by mass or more and 99.9% by mass or less, even more preferably 45% by mass or more and 99.9% by mass or less, especially more preferably 50% by mass or more and 99.9% by mass or less.

### <Other Resin Components>

The thermoplastic resin composition in this aspect may contain, in addition to the above-mentioned cellulose-containing solid material and the thermoplastic resin, a resin miscible with the thermoplastic resin composition.

### <Inorganic Filler, Organic Filler>

The thermoplastic resin composition in this aspect may contain a filler. Examples of inorganic filler include silica powder such as spherical or ground molten silica, crystal silica, etc.; alumina powder, glass powder, glass fibers, glass flakes, mica, talc, calcium carbonate, alumina, alumina hydrate, boron nitride, aluminum nitride, silicon nitride, silicon carbide, titanium nitride, zinc oxide, tungsten carbide, magnesium oxide, etc.

Organic filler includes carbon fibers, aramid fibers, paper powder, cellulose fibers, cellulose powder, chaff powder, fruit husks, nut powder, chicken powder, starch, etc.

One alone or two or more of inorganic fillers and organic fillers may be used either singly or as combined, and the content thereof may be determined in accordance with the intended object. When the composition contains an inorganic filler and/or an organic filler, it is desirable that the content of the inorganic filler and/or the organic filler is a suitable one from the viewpoint of securing good physical properties and moldability. From this viewpoint, the content of the inorganic filler and/or the organic filler is preferably such that the upper limit of the content is more than 0 parts by mass and 400 parts by mass or less relative to 100 parts by mass of the total resin fraction in the thermoplastic resin composition, more preferably 0 parts by mass or more and 300 parts by mass or less, even more preferably 0 parts by mass or more and 250 parts by mass or less.

### <Other Additives>

Various additives of a compatibilizer and a surfactant may be further added to the thermoplastic resin composition of the present invention in accordance with the intended object and within a range not detracting from the properties of the cured product to be formed of the composition.

As a compatibilizer, a resin prepared by adding maleic anhydride, an epoxy or the like to the above-mentioned thermoplastic resin to introduce a polar group thereinto, for example, a maleic anhydride-modified polyethylene resin or a maleic anhydride-modified polypropylene resin may be used, and various commercially-available compatibilizers may also be used together.

The surfactant includes linear fatty acids such as stearic acid, palmitic acid, oleic acid, etc., and branched cyclic fatty acids with rosins, etc., but is not specifically limited thereto.

Further, as other additives that may be incorporated in the composition in addition to the above-mentioned ones, there are mentioned a flexibilizer, a heat stabilizer, a UV absorbent, a flame retardant, an antistatic agent, a defoaming agent, a thixotropy imparting agent, a mold release agent, an antioxidant, a plasticizer, a stress reducer, a coupling agent, a dye, a light scattering agent, a small amount of a thermoplastic resin, etc.

[Method for Producing Thermoplastic Resin Composition]

A method for producing the thermoplastic resin composition in this aspect of the present invention includes a separation step of separating a cellulose-containing solid material after heat treatment of a botanical biomass as a raw material in a mixed solvent of water and at least one alcohol selected from aliphatic alcohols having 4 to 8 carbon atoms, and subsequently to the separation step, a mixing step of mixing a thermoplastic resin and the cellulose-containing solid material.

The separation step conforms to the above-mentioned production method for a cellulose-containing solid material.

Subsequently to the separation step, a mixing step is carried out, in which the above-mentioned thermoplastic resin, the cellulose-containing solid material and other various optional components are kneaded to give a thermoplastic resin composition.

In the mixing step, preferably, mixing is performed in such a blending ratio that the thermoplastic resin is 30% by mass or more and 99.9% by mass or less as a solid content and the cellulose-containing solid material is 0.1% by mass or more and 70% by mass or less, based on the total amount of the thermoplastic resin composition.

The blending and kneading in this stage may be carried out in a method using ordinary instruments, for example, after premixing with a ribbon blender, a drum tumbler or the like, using a Henschel mixer, a Banbury mixer, a single-screw extruder, a twin-screw extruder, a multi-screw extruder, a co-kneader or the like. The heating temperature during kneading may be adequately selected in a range of generally 100 to 300° C. The other components than the thermoplastic resin may be previously kneaded in melt with the thermoplastic resin to prepare a master batch, which may be added to the reaction system.

The thermoplastic resin composition in this aspect may be molded into various molded articles, using the above-mentioned melt-kneading molding machine, or using pellets of the composition as a raw material and according to an injection molding method, an injection compression molding method, an extrusion molding method, a blow molding method, a press molding method, a vacuum molding method, a foam molding method, etc. In particular, the composition is favorably used for producing an injection-molded article in a process of preparing a pelletized molding material according to the above-mentioned melt-kneading method and then molding the resultant pellets in a mode of injection molding or injection compression molding to give a molded article. As the injection molding method, a gas injection molding method may be employed for preventing formation of sink marks on the appearance and for reducing the weight of the molded article.

The cellulose-containing solid material in this aspect is in the form of fine particles during kneading with the resin composition, and therefore may be used directly as it is in a master batch without pretreatment such as conventional opening step.

### EXAMPLES

Hereinunder the present invention is described in more detail with reference to Examples. The present invention is not restricted to the following Examples.

### [Evaluation Method]

### <Compositional Analysis of Cellulose-Containing Solid Material>

The component composition in Table 1 was calculated according to constituent sugar analysis after the following pretreatment.

### (Pretreatment)

As pretreatment, the raw material to be a sample was ground using a Wiley mill, and dried at 105° C.

### (Analysis of Constituent Sugar)

An appropriate amount of the sample of a cellulose-containing solid material was metered, 72% sulfuric acid was added, and left at 30° C. for 1 hour with stirring as needed. While mixed and diluted with pure water, the reaction liquid was completely transferred into a pressure bottle and treated at 120° C. in an autoclave for 1 hour, and subsequently filtered into a filtrate and a residue. The monosaccharide in the filtrate was quantified through high-performance liquid chromatography. C6 polysaccharide (mainly glucan) was defined as cellulose, and C5 polysaccharide (mainly xylan) was as hemicellulose.

### (Lignin)

The residue obtained through filtration in the process of constituent sugar analysis was dried at 105° C., and the weight thereof was measured to calculate the degradation residue ratio. By ash correction, the lignin content was calculated.

### <Measurement of Water Content in Cellulose-Containing Solid Material>

The water content in a cellulose-containing solid material was measured according to a freeze-drying method.

### <Modulus of Tensile Elasticity, Elongation at Break>

The modulus of tensile elasticity and the elongation at break of a resin composition were measured according to JIS K6251-3.

### <1% Thermogravimetric Loss Temperature>

Using the following apparatus and under the following conditions, the 1% thermogravimetric loss temperature of a resin composition was measured. Apparatus: by Hitachi High-Technologies Corporation (name of apparatus: TG/DTA6300)

Measurement Conditions: Automatic step temperature-rising program, temperature-rising speed: 10° C./min (25° C. to 600° C.), nitrogen atmosphere, threshold value: 10 μg/min

### <Outward Appearance, Dispersibility>

10 g of a resin composition was pressed at 200° C. into a 1-mm thick sheet. A test piece of 1 cm² was cut out of the resultant sheet. The test sheet was checked for the presence or absence of bubbles therein, using an optical microscope. In the 1-mm thick sheet, the number of fiber aggregates having a size of 0.1 mm or more in an area of 1 cm² was counted, and the data of three samples were averaged. Those having an average value of 1 to 5 were ranked as A, those having an average value of 5 to 10 were as B, and those having an average value of 10 to 20 were as C.

### Production Examples for Cellulose-Containing Solid Material

### Production Example 1

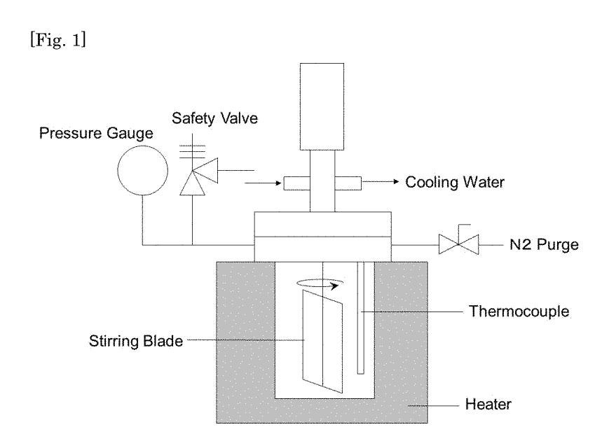

Bagasse as a botanical biomass (having a sample size of 5 cm square or less), and a mixed solvent of water/1-butanol in a ratio of 8/1 were put into a SUS (stainless) batch-type device having an inner volume of 30 L (FIG. 1). The total amount of the solvent was 13,230 g. Regarding the concentration of the raw material charged, raw material/solvent=1/10.

The SUS batch-type device was purged with nitrogen, then heated up to 200° C., and the contents were treated for 2 hours. The treatment time was the lapse time after the device reached 200° C. For temperature measurement, a thermocouple was used.

After the treatment, the SUS batch-type device was cooled, and after the temperature lowered to around room temperature, the solid fraction and the liquid phase were separated from each other through filtration.

8,400 g of water was added to the solid fraction, stirred for 30 minutes, and the solid fraction and the liquid phase were separated through filtration. The operation was repeated three times to give a cellulose-containing solid material A. The results of composition analysis of the cellulose-containing solid material A are shown in Table 1.

### Production Examples 2 to 6

The botanical biomass shown in Table 1 was treated using the same mixture solution as in Production Example 1 and under the same conditions as in Production Example 1 to separate the solid fraction and the liquid phase. Further, according to the same operation as in Production Example 1, cellulose-containing solid materials B to F were obtained. The results of composition analysis of the resultant cellulose-containing solid materials are shown in Table 1.

TABLE 1

| | Cellulose-Containing Solid Material | | | | | |
|---|---|---|---|---|---|---|
| | A | B | C | D | E | F |
| Botanical Biomass | bagasse | bagasse | bagasse | bagasse | Japanese cedar | bamboo |
| Production Area | Thailand | Thailand | Vietnam | Brazil | Japan | Japan |
| Cellulose (mass %) | 62 | 76 | 70 | 78 | 70 | 90 |
| Lignin (mass %) | 21 | 14 | 10 | 8 | 25 | 7 |
| Hemicellulose (mass %) | 2 | 1 | 1 | 1 | 1 | 1 |
| Other Components (mass %) | 15 | 9 | 19 | 13 | 4 | 2 |

### Thermoplastic Resin Composition

### Example 1

Among the cellulose-containing solid materials shown in Table 1, the cellulose-containing solid material A obtained in Production Example 1 was selected, and the cellulose-containing solid material A, PP (manufactured by Prime Polymer Co., Ltd., “E-105GM”), and the component shown in Table 2 were put into a kneader (manufactured by Toyo Seiki Seisaku-sho, Ltd., product name “Labo Plastomill”), kneaded at 120° C. for 5 minutes, and further kneaded at 210° C. for 3 minutes to give a resin composition.

The blending amount of the cellulose-containing solid material A was 10% by mass as the solid content relative to the total mass of the thermoplastic resin composition.

The resultant kneaded thermoplastic resin composition was finished into a tabular plate using a press forming machine (manufactured by Kodaira Seisakusho Co., Ltd.). Subsequently, this was blanked with a No. 3 dumbbell to give a sample for tensile test. The sample production and the tensile test were carried out according to JIS K6251-3. On the basis of the above-mentioned evaluation methods, the thermoplastic resin composition was evaluated.

### Comparative Example 1

A thermoplastic resin composition was produced by kneading in the same manner as above, except that cellulose nanofibers (manufactured by Mori Machinery Corporation, “CNF250”) were used in place of the cellulose-containing solid material A obtained in Production Example 1, and was molded under the same conditions as above to give a sample of Comparative Example 1.

### Comparative Example 2

A thermoplastic resin composition was produced by kneading in the same manner as above, except that lignocellulose nanofibers (manufactured by Mori Machinery Corporation, “LignoCNF45”) were used in place of the cellulose-containing solid material A obtained in Production Example 1, and was molded under the same conditions as above to give a sample of Comparative Example 2.

TABLE 2

| | | | Com- | Com- |
|---|---|---|---|---|
| | | | parative | parative |
| | | Exam- | Exam- | Exam- |
| | | ple 1 | ple 1 | ple 2 |
| Blending | Cellulose-Containing Solid | 10 | 0 | 0 |
| Formulation | Material A | | | |
| (mass %) | Cellulose Nanofibers | 0 | 10 | 0 |
| | Lignocellulose Nanofibers | 0 | 0 | 10 |
| | Polypropylene | 90 | 90 | 90 |
| Evaluation | Water Content in Cellulose- | 82 | 94 | 90 |
| Results | Containing Solid Material (%) | | | |
| | Modulus of Tensile Elasticity | 1760 | 1680 | 1680 |
| | (MPa) | | | |
| | Elongation at Break (%) | 15.8 | 11.8 | 6.7 |
| | 1% Thermogravimetric Loss | 305.9 | 297.4 | 277.8 |
| | Temperature (° C.) | | | |
| | Appearance | No | No | with |
| | | bubble | bubble | bubbles |
| | Dispersibility | A | C | B |

### [Evaluation Results]

The sample of Example 1 had a modulus of tensile elasticity of 1,760 MPa, and improvement in the modulus of elasticity thereof was recognized as compared with those of Comparative Examples 1 and 2 having 1,680 MPa each.

The elongation at break of the sample of Example 1 was 15.8%, and was improved relative to 11.8% of Comparative Example 1 and 6.7% of Comparative Example 2.

The water content in the cellulose-containing solid material A used in Example 1 was smaller than that in the samples of Comparative Examples. In addition, the cellulose-containing solid material produced in Production Example 1 was considered to be more openable in the state of kneading with the thermoplastic resin. Consequently, the cellulose-containing solid material A used in Example 1 was considered to be more dispersible in the hydrophobic resin.

The dispersibility in Example 1 was 3.3 (rank A), that in Comparative Example 1 was 11.3 (rank C) and that in Comparative Example 2 was 8 (rank B), the cellulose-containing solid material produced in Production Example 1 was confirmed to be well dispersible in the resin composition.

Regarding the result of the 1% thermogravimetric loss temperature, the temperature in Example 1 was 305.9° C., that in Comparative Example 1 was 297.4° C. and that in Comparative Example 2 was 277.8° C. Like this, there was confirmed a significant difference in the value of the 1% thermogravimetric loss temperature between Example and Comparative Examples.

The cellulose-containing solid material used in the sample in Example 1 was not processed in an opening step, but it could be considered that, by kneading with the thermoplastic resin, the cellulose-containing solid material could be opened into fine fibers and could be well dispersed. According to the present invention, an opening step for the cellulose-containing solid material can be omitted.

1. A thermoplastic resin composition comprising a cellulose-containing solid material obtained after heat treatment of a botanical biomass as a raw material in a mixed solvent of water and at least one alcohol selected from aliphatic alcohols having 4 to 8 carbon atoms, and a thermoplastic resin.

2. The thermoplastic resin composition according to claim 1, wherein the thermoplastic resin is contained in an amount of 30% by mass or more and 99.9% by mass or less as a solid content and the cellulose-containing solid material is contained in an amount of 0.1% by mass or more and 70% by mass or less, based on the total amount of the thermoplastic resin composition.

3. The thermoplastic resin composition according to claim 1, wherein the cellulose-containing solid material is obtained after treatment under the following conditions:
Condition A: the concentration of the raw material to be charged into the mixed solvent is 1% by mass or more and 50% by mass or less,
Condition B: the treatment temperature is 100° C. or higher and 350° C. or lower, and
Condition C: the treatment time is 0.1 hours or more and 10 hours or less.

4. A thermoplastic resin composition comprising a cellulose-containing solid material obtained after heat treatment of a botanical biomass as a raw material in a mixed solvent of water and at least one alcohol selected from aliphatic alcohols having 4 to 8 carbon atoms, and a thermoplastic resin, wherein the cellulose-containing solid material contains, as a solid content, cellulose and a cellulose degradation product obtained through degradation of cellulose in an amount of 60% by mass or more and 90% by mass or less, lignin in an amount of 5% by mass or more and 35% by mass or less, and hemicellulose and a hemicellulose degradation product obtained through degradation of hemicellulose in an amount of 0% by mass or more and 5% by mass or less, based on the total amount of the cellulose-containing solid material.

5. The thermoplastic resin composition according to claim 1, wherein the thermoplastic resin is an amorphous thermoplastic resin having a glass transition temperature of 200° C. or lower, or a crystalline thermoplastic resin having a melting point of 200° C. or lower.

6. The thermoplastic resin composition according to claim 1, wherein the thermoplastic resin is at least one selected from an olefinic resin, a styrenic resin, a nylon resin and an acrylic resin.

7. The thermoplastic resin composition according to claim 1, wherein the thermoplastic resin is contained in an amount of 70% by mass or more and 99.9% by mass or less and the cellulose-containing solid material is contained in an amount of 0.1% by mass or more and 30% by mass or less based on the total amount of the thermoplastic resin composition.

8. The thermoplastic resin composition according to claim 1, wherein the molar ratio of water to the alcohol (water/alcohol) in the mixed solvent is from 1/1 to 40/1.

9. The thermoplastic resin composition according to claim 1, wherein the aliphatic alcohol is at least one selected from 1-butanol, 2-butanol and 2-methyl-1-propanol.

10. The thermoplastic resin composition according to claim 1, wherein the botanical biomass is a herbaceous biomass.

11. A method for producing a thermoplastic resin composition, comprising:
a separation step of separating a cellulose-containing solid material after heat treatment of a botanical biomass as a raw material in a mixed solvent of water and at least one alcohol selected from aliphatic alcohols having 4 to 8 carbon atoms, and
subsequently to the separation step, a mixing step of mixing a thermoplastic resin and the cellulose-containing solid material.

12. The method for producing a thermoplastic resin composition according to claim 11, wherein in the mixing step, mixing is performed in such a blending ratio that the thermoplastic resin could be 30% by mass or more and 99.9% by mass or less as a solid content and the cellulose-containing solid material could be 0.1% by mass or more and 70% by mass or less, based on the total amount of the thermoplastic resin composition.

13. The method for producing a thermoplastic resin composition according to claim 11, wherein in the separation step, the cellulose-containing solid material is separated after treated under the following conditions:
Condition A: the concentration of the raw material to be charged into the mixed solvent is 1% by mass or more and 50% by mass or less,
Condition B: the treatment temperature is 100° C. or higher and 350° C. or lower, and
Condition C: the treatment time is 0.1 hours or more and 10 hours or less.
